(19) United States
(12) Patent Application Publication
(10) Pub. No.: US 2013/0056241 A1
(43) Pub. Date: Mar. 7, 2013

(54) EMITTER WIRE WITH LAYERED CROSS-SECTION

(71) Applicants: Guilian Gao, San Jose, CA (US); Nels Jewell-Larsen, San Jose, CA (US); Giles Humpston, Buckinghamshire (GB)

(72) Inventors: Guilian Gao, San Jose, CA (US); Nels Jewell-Larsen, San Jose, CA (US); Giles Humpston, Buckinghamshire (GB)

(73) Assignee: TESSERA, INC., San Jose, CA (US)

(21) Appl. No.: 13/302,811

(22) Filed: Nov. 22, 2011

Related U.S. Application Data
(60) Provisional application No. 61/530,874, filed on Sep. 2, 2011.

(51) Int. Cl. H01B 5/00; F28F 13/00; F04B 19/00; B05D 5/12

(52) U.S. Cl. 174/126.2; 427/125; 165/120; 417/48

(57) ABSTRACT

By selecting different materials for each layer, a multi-layered electrode structure can be made with superior performance characteristics. For example, a multilayered electrode can include a high tensile strength tungsten core, a conductive intermediate palladium, palladium-nickel, or other platinum group metal layer for generating a corona discharge, and a hardened layer comprising rhodium or other platinum group metal or alloy of the same to resist frictional abrasion during removal of silica dendrites that accumulate on the electrode surface during operation.

### CROSS-REFERENCE TO RELATED APPLICATIONS

The current application claims the benefit of U.S. Provisional Application 61/530,874, filed Sep. 2, 2011, which is incorporated herein in its entirety by reference.

### BACKGROUND

1. Field of the Invention

This application relates generally to electrodes in electrohydrodynamic or electrostatic devices such as electrohydrodynamic fluid accelerators and electrostatic precipitators, and particularly to classes of materials that can be used to form such electrodes.

2. Description of the Related Art

Many electronic devices and mechanically operated devices require airflow to help cool certain operating systems by convection. Cooling helps prevent device overheating and improves long-term reliability. It is known to provide cooling airflow with the use of fans or other similar moving mechanical devices; however, such devices generally have limited operating lifetimes, produce noise or vibration, consume power or suffer from other design problems.

The use of an ion flow air mover device, such as an electrohydrodynamic device or electro-fluid dynamic device, may result in improved cooling efficiency, reduced vibrations, power consumption, electronic device temperatures, and noise generation. This may reduce overall device lifetime costs, device size or volume, and may improve electronic device performance or user experience.

Devices built using the principle of the ionic movement of a fluid are variously referred to in the literature as ionic wind machines, electric wind machines, corona wind pumps, electro-fluid-dynamics (EFD) devices, electrohydrodynamic (EHD) thrusters and EHD gas pumps. Some aspects of the technology have also been exploited in devices referred to as electrostatic air cleaners or electrostatic precipitators.

Ozone (0₃), while naturally occurring, can also be produced during operation of various electronics devices, including EHD devices, photocopiers, laser printers and electrostatic air cleaners, and by certain kinds of electric motors and generators, etc. Elevated ozone levels have been associated with respiratory irritation and certain health issues. Therefore, ozone emission can be subject to regulatory limits such as those set by the Underwriters Laboratories (UL) or the Environmental Protection Agency (EPA). Accordingly, techniques to reduce ozone concentrations have been developed and deployed to catalytically or reactively break down ozone (O₃) into the more stable diatomic molecular form (O₂) of oxygen.

Some of the characteristics in which known emitter and collector materials are often deficient entail surface chemistry and catalysis. For example, EHD device performance reduction or failure can be caused by gradual coating of the emitter with silica. Still other EHD devices produce unacceptable concentrations of ozone in the air transported through the device. Additionally, some electrodes may be susceptible to oxidation, corona erosion, or accumulation of detrimental materials. The term “corona erosion” refers to various adverse effects from a plasma discharge environment including enhanced oxidation, and etching or sputter of emitter surfaces. In general, corona erosion can result from any plasma or ion discharge including, silent discharge, AC discharge, dielectric barrier discharge or the like.

Generally, many desirable electrode materials properties can be achieved by forming the emitter and collector of particular metals, e.g., to provide desired conductivity, hardness and strength. However, some materials are susceptible to adverse effects from a corona discharge environment. For example, a tungsten electrode core can be susceptible to rapid corona erosion once an overlaying protective layer is compromised, e.g., via microcracking or abrasion.

Accordingly, improvements are sought in enhancing electrode performance by providing improved performance characteristics through layered combination of selected materials.

### SUMMARY

It has been discovered that layered electrode constructions may be employed in emitter and collector electrodes or other electrodes or components of EHD devices to provide a range of desirable materials characteristics. The layered electrode constructions include a core material selected, e.g., for tensile strength, and encased in at least two additional electrode materials. For example, one or more intermediate layers can include palladium and nickel for generation of plasma discharge under an applied voltage, while a hardened layer, e.g., of rhodium, provides a durable, hard surface from which accumulated silica dendrites may be readily removed.

Thus, electrohydrodynamic device emitter and collector electrodes may be of a layered construction to provide a range of performance characteristics. To provide desirable combinations of characteristics in varied applications, these layers may be further formed of multiple materials selected to exhibit a combination of materials performance characteristics.

Advantageous electrode characteristics can include, e.g.:
1—Electrical conductivity
2—Resistance to erosion by corona
3—Resistance to oxidation
4—Non-stick/low adhesion surface for silica and dust
5—Low ozone generation or catalytic activity towards ozone
6—Low coefficient of friction
7—Moderate hardness and tensile strength
8—Resistance to high temperature
9—Resistance to thermal cycling
10—Resistance to friction abrasion during silica dendrite removal

It has been discovered that by selecting different materials for each layer, a multi-layered electrode structure can be made with superior performance characteristics. For example, a multilayered electrode can include a high tensile strength tungsten core, a conductive intermediate palladium, palladium-nickel, or other platinum group metal layer for generating a corona discharge, and a hardened layer comprising rhodium or other platinum group metal or alloy of the same to resist frictional abrasion during removal of silica dendrites that accumulate on the electrode surface during operation.

In some implementations, an intermediate layer of an emitter electrode includes palladium and palladium-nickel alloys, and a subsequent rhodium layer further includes a conditioning material, e.g., silver. Palladium exhibits many desirable characteristics such as high electrical conductivity, while rhodium is hard and durable, and silver is an excellent catalyst for ozone at the electrode surface.

Rhodium has been shown through experimentation to be sufficiently hard and durable to withstand repeated wiping with a frictional cleaning device during dendrite removal. A certain amount of force is applied between a frictional cleaning surface and the electrode surface to effectively dislodge silica dendrites. Both the frictional cleaning surface and the dendrites present abrasive features. Accordingly, it is desirable to present an electrode surface that can withstand the abrasive forces of repeated cleaning cycles. In some implementations, it may be desirable to occasionally condition the electrode surface to impede dendrite growth, prevent surface deterioration, or to provide a sacrificial layer such as ozone reducing material, e.g., silver.

Silver (Ag) is an excellent candidate for imparting ozone reduction characteristics to an emitter electrode, e.g., a corona emitter wire. Silver, however, does not generally exhibit long life in the emitter wire corona environment. Thus, the silver can be periodically deposited on the electrode surface, e.g., during or between frictional cleaning cycles. For example, a frictional cleaning device can include a wearable or otherwise depositable silver material.

It has been discovered that layered electrode coating structures can further mitigate cracking or at least propagation of cracks and corona erosion beyond a compromised layer under corona plasma conditions. For example, it has been discovered that the electrode may be made robust to micro-cracking of the electrode surface by creation of an intermediate layer(s) that is less susceptible to deterioration in a corona environment thereby mitigating exposure of the electrode core material to the plasma discharge environment following compromise of the coating and enabling the electrode to maintain mechanical and electrical integrity. For example, an ozone reducing material or other exposed rhodium material may be deposited as an incomplete layer or exhausted without compromising the functionality of the underlying emitter electrode layers or core.

In some implementations, a multi-layered structure is formed over the electrode core material. With this layered structure, the sublayers prevent propagation of micro-cracks in a successive layer that could expose underlying electrode core materials, which may otherwise deteriorate more quickly in the corona plasma environment. For example, a particular implementation includes a multi-layered structure including, starting from the outermost surface, a coating of an ozone reducing material such as silver deposited over a hard rhodium layer. An intermediate layer is selected to be resistant to corona plasma environment, e.g., palladium, or other platinum (Pt) group metal. Additional suitable intermediate layer materials can include alloys of platinum group metals of varying hardness. The corona plasma resistant material can be bound by an adhesion material, such as nickel or gold, to a mechanically robust, high-strength electrode core material such as titanium, steel, tungsten, tantalum, molybdenum, nickel and alloys containing these metals. Any number of adhesion layers or other intermediate layers may be used between any two layers described herein as adjacent layers.

In some applications, a method of producing a layered electrode system includes depositing materials on an electrode core, e.g., a tungsten core, in the following order: nickel (adhesion layer), palladium-nickel, rhodium (hard layer), silver (sacrificial ozone reducing coating). In some implementations, multiple palladium-nickel layers of varying alloy compositions may be arranged to provide increased hardness towards the electrode surface and increase crack resistance at an inner layer.

In some implementations, the longevity of an EHD device may be improved if dust or other detrimental materials do not accumulate on the emitter and collector electrode surfaces. Different pure metals suitable for use as emitter or collector electrodes generally exhibit similar relatively high friction coefficients. However, non-metal materials such as carbon graphite are known to have relatively low friction coefficients and can be coated onto or even partially absorbed by a surface layer. For example, a solid solution including graphite can provide a low coefficient of friction and/or low surface adhesion to an electrode surface.

In some implementations, one aspect of the invention features a multi-layered electrode for use in an electrohydrodynamic device. The electrode includes an electrode core material and intermediate layer about the core material, the intermediate layer susceptible to adverse effects from a plasma discharge environment. A further electrode layer provides protection from, e.g., abrasion during frictional cleaning of the electrode.

In some implementations, the intermediate and further electrode layers comprise different compositions of platinum group metals, e.g., one of pure palladium and another of a palladium-nickel alloy.

In some implementations, additional intermediate layers can provide added protection, e.g., following micro-crack formation, pinhole formation, defect formation, corona erosion or consumption of a portion of a subsequent layer. For example, a barrier material can be disposed between the electrode core material and the coating. The barrier material can be selected to substantially mitigate exposure of the electrode core material to the adverse effects of the plasma discharge environment following compromise of the coating, e.g., due to micro-cracking, pin hole formation, coating defect formation or corona erosion of the coating.

In some implementations, an adhesion promoting layer is disposed between adjacent layers. In some implementations, at least one of the barrier material and the adhesion promoting layer includes at least one of nickel, gold, titanium-tungsten alloy and chromium. In some implementations, at least one of the barrier material and the adhesion promoting material further includes multiple distinct layers. In some implementations, the multiple layers of the at least one of the barrier material and the adhesion promoting material include nickel, rhodium, iridium, platinum and palladium.

In some implementations, the electrode core material includes at least one of tungsten, titanium, steel, tantalum, molybdenum, nickel or their alloys.

In some implementations, one aspect of the invention features an electrohydrodynamic device including one or more collector electrodes; and a layered emitter electrode in spaced relation to the one or more collector electrodes. The layered emitter electrode and one or more collector electrodes are energizable to motivate fluid flow along a flow path. The layered emitter electrode includes an electrode core material, an intermediate Pt group layer deposited on the core material, and a hard further layer comprising rhodium.

In some implementations, a further electrode coating exhibits one or more of ozone reactivity, resistance to oxidation, resistance to corona erosion, low coefficient of friction, and low surface adhesion.

In some implementations, one aspect of the invention features an apparatus including an enclosure and a thermal management assembly for use in convection cooling of one or more devices within the enclosure. The thermal management assembly defines a flow path for conveyance of air between portions of the enclosure over heat transfer surfaces positioned along the flow path to dissipate heat generated by the one or more devices. The thermal management assembly includes an electrohydrodynamic (EHD) fluid accelerator including one or more collector electrodes and a layered emitter electrode in spaced relation to the one or more collector electrodes. The layered emitter electrode and one or more collector electrodes are energizable to motivate fluid flow along a flow path. The layered emitter electrode includes: an electrode core material, one or more intermediate layers about the core material, and a further electrode layer. The intermediate and further electrode layers are of differing compositions of platinum group metals, e.g., palladium, rhodium, or a palladium-nickel alloy.

In some implementations, the one or more devices includes one of a computing device, laptop computer, tablet computer, smart phone, projector, copy machine, fax machine, printer, radio, audio or video recording device, audio or video playback device, communications device, charging device, power inverter, light source, medical device, home appliance, heater, air cleaner, power tool, toy, game console, set-top console, television, and video display device.

In some cases, the electrode surface presents an ozone reducing material, e.g., catalyst, selected from a group that includes: manganese dioxide (MnO₂); silver (Ag); silver oxide (Ag₂O); and an oxide of copper (CuO). The ozone reducing material can be a component of the further layer that is exposed through frictional cleaning, or can be a sacrificial coating deposited on the electrode.

In some implementations, an electrohydrodynamic fluid accelerator includes a layered emitter electrode (e.g., tungsten, palladium-nickel, and rhodium) and at least one collector electrode energizable to motivate fluid flow along a flow path. The collector electrode is coupled into a heat transfer pathway to dissipate heat into the fluid flow.

In some applications, a method of making a product includes providing an electrode core material, providing a palladium layer on the electrode core material, and providing a rhodium layer over the palladium layer. In some applications, forming an electrode layer includes one of dip coating, spray coating or electroplating an underlying structure with the selected layer material. In some applications, forming an electrode layer includes one of electroplating, anodizing or alodizing an underlying structure.

In some applications, one aspect of the invention features a method of forming an electrode. The method includes providing a tungsten or tungsten alloy electrode core material and providing one or more intermediate conductive platinum group metal layers over the tungsten or tungsten alloy electrode core material. The method further includes providing a further electrode material comprising a second platinum group metal of a composition different from that of the one or more intermediate conductive platinum group metal layers.

In some applications, the further electrode material comprises rhodium. In some applications, the further electrode material comprises a palladium-nickel alloy.

In some applications, the method includes providing a barrier layer between the electrode core material and a subsequent layer to substantially mitigate exposure of the electrode core material due to at least one of micro-cracking pin hole formation, coating defect formation and corona erosion of more outward layers. In some implementations, the barrier layer is a palladium layer over the tungsten core to protect the core against propagation of micro-cracks formed in a more outward layer of palladium-nickel alloy.

In some applications, the method includes providing an adhesion promoting material between two other layers. In some applications, at least one of the adhesion promoting material and the barrier material includes nickel.

In some applications, the method further includes positioning heat transfer surfaces downstream of, and proximate to, the collector electrode; and fixing an emitter electrode proximate to the collector electrode that, when energized, generates ions and thereby motivates fluid flow over the heat transfer surfaces. The emitter electrode, collector electrode and heat transfer surfaces are so positioned and fixed to constitute a thermal management assembly.

In some applications, the method includes introducing the thermal management assembly into an electronic device and thermally coupling a heat dissipating device thereof to the heat transfer surfaces.

In the present application, some implementations of the devices illustrated and described herein are referred to as electrohydrodynamic fluid accelerator devices, also referred to as “EHD devices,” “EHD fluid accelerators,” and the like. Such devices are suitable for use as a component in a thermal management solution to dissipate heat generated by an electronic circuit amongst other things. For concreteness, some implementations are described relative to particular EHD device configurations in which a corona discharge at or proximate to an emitter electrode operates to generate ions that are accelerated in the presence of electrical fields, thereby motivating fluid flow. While corona discharge-type devices provide a useful descriptive context, it will be understood (based on the present description) that other ion generation techniques may also be employed. For example, in some implementations, techniques such as silent discharge, AC discharge, dielectric barrier discharge (“DBD”) or the like may be used to generate ions that are in turn accelerated in the presence of electrical fields and to motivate fluid flow.

Based on the description herein, persons of ordinary skill in the art will appreciate that use of a multi-layered electrode as described herein may likewise benefit systems that employ other ion generation techniques to motivate fluid flow. For example, a DBD system that provides electrical discharge between two electrodes separated by an insulating dielectric barrier may generate ozone, which may be mitigated using techniques described herein. Thus, in the description and claims that follow, the terms “emitter electrode” and “electrohydrodynamic fluid accelerator” are meant to encompass a broad range of devices without regard to the particular ion generation techniques employed.

In some cases, the emitter electrode and the collector electrode(s) together at least partially define an electrohydrodynamic fluid accelerator. For example, the emitter electrode and the collector electrode(s) can be positioned relative to one another such that, when energized, ions are generated therebetween and fluid flow is thereby motivated along a fluid flow path.

In some implementations, the electrohydrodynamic fluid accelerator includes the emitter electrode and is energizable to motivate fluid flow along a fluid flow path, and the collector electrode surfaces are disposed upstream of the electrohydrodynamic fluid accelerator along the fluid flow path and are operable as part of an electrostatic precipitator.

In some implementations, a layered electrode including an exposed rhodium layer is energizable to contribute to flow of ion current in one of an electrohydrodynamic fluid accelerator and an electrostatic precipitator. In some implementations, both the emitter electrode and the collector electrode(s) are operable as part of an electrohydrodynamic fluid accelerator. Still, in some implementations, the emitter electrode and the collector electrode(s) are operable as part of an electrostatic precipitator. In some cases, at least one additional electrode surface is disposed either upstream or downstream of the electrohydrodynamic fluid accelerator or electrostatic precipitator along the fluid flow path.

In some implementations, the EHD device is part of a thermal management assembly for use in convective cooling of one or more devices within an enclosure. The thermal management assembly defines a flow path for conveyance of air between portions of the enclosure over heat transfer surfaces positioned along the flow path to dissipate heat generated by the one or more devices. The thermal management assembly includes an electrohydrodynamic (EHD) device including emitter and collector electrodes energizable to motivate fluid flow along the flow path. In some implementations, one or more devices includes one of a computing device, projector, copy machine, fax machine, printer, radio, audio or video recording device, audio or video playback device, communications device, charging device, power inverter, light source, medical device, home appliance, power tool, toy, game console, television, and video display device.

Advantages of use of an EHD device for thermal management in such devices includes, e.g., substantially silent operation, reduced power consumption, reduced vibration, reduced thermal solution footprint and volume, and form factor flexibility, e.g., capability to utilize space around other electronics.

### BRIEF DESCRIPTION OF THE DRAWINGS

The present invention may be better understood, and its numerous objects, features, and advantages made apparent to those skilled in the art by referencing the accompanying drawings.

FIG. 1 is a depiction of certain basic principles of electrohydrodynamic (EHD) fluid flow.

FIG. 2 is a depiction of an illustrative high voltage power supply configuration in which emitter and collector electrodes are energized to motivate fluid flow.

FIG. 3 depicts a cross-sectional view of one embodiment of a layered electrode.

FIG. 4 depicts a block diagram of a method of making the layered electrode of FIG. 3.

FIG. 5 depicts a cross-sectional view of another embodiment of a layered electrode.

FIG. 6 depicts a block diagram of a method of making the layered electrode of FIG. 5.

FIG. 7 depicts a schematic block diagram illustrating one implementation of an environment in which a layered electrode may operate.

FIG. 8 is a rear view of a display device including an EHD device in which a layered electrode may operate to motivate airflow along a localized flow path.

FIGS. 9a-b depict top views of tablet or handheld computing devices including an EHD in which a multi-layered electrode may operate to motivate airflow.

The use of the same reference symbols in different drawings indicates similar or identical items.

### DETAILED DESCRIPTION

### Electrohydrodynamic (EHD) Fluid Acceleration, Generally

Some implementations of thermal management systems described herein employ EHD devices to motivate flow of a fluid, typically air, based on acceleration of ions generated as a result of corona discharge. Other implementations may employ other ion generation and motivation techniques and will nonetheless be understood in the descriptive context provided herein. For example, in some implementations, techniques such as silent discharge, AC discharge, dielectric barrier discharge or the like may be used to generate ions that are in turn accelerated in the presence of electrical fields to motivate fluid flow.

In general, EHD technology uses ion flow principles to move fluids (e.g., air molecules). Basic principles of EHD fluid flow are reasonably well understood by persons of skill in the art. Accordingly, a brief illustration of ion flow using corona discharge principles in a simple two electrode system sets the stage for the more detailed description that follows.

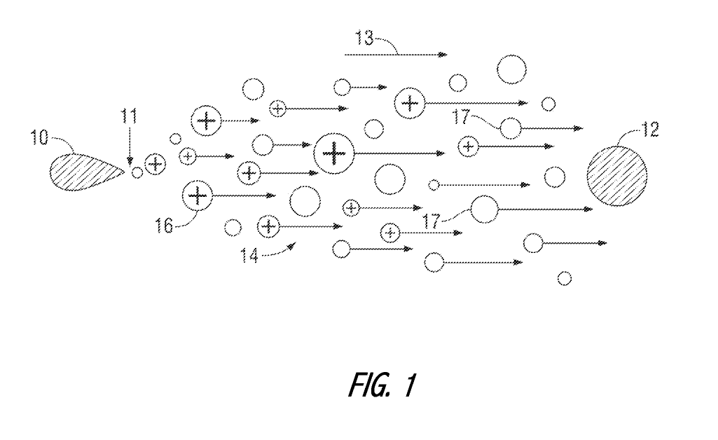

With reference to the illustration in FIG. 1, EHD principles include applying a high intensity electric field between a first electrode 10 (often termed the “corona electrode,” the “corona discharge electrode,” the “emitter electrode” or just the “emitter”) and a second electrode 12. Fluid molecules, such as surrounding air molecules, near the emitter discharge region 11 become ionized and form a stream 14 of ions 16 that accelerate toward second electrode 12, colliding with neutral fluid molecules 17. During these collisions, momentum is imparted from the stream 14 of ions 16 to the neutral fluid molecules 17, inducing a corresponding movement of fluid molecules 17 in a desired fluid flow direction, denoted by arrow 13, toward second electrode 12. Second electrode 12 may be variously referred to as the “accelerating,” “attracting,” “target” or “collector” electrode. While stream 14 of ions 16 is attracted to, and generally neutralized by, second electrode 12, neutral fluid molecules 17 continue past second electrode 12 at a certain velocity. The movement of fluid produced by EHD principles has been variously referred to as “electric,” “corona” or “ionic” wind and has been defined as the movement of gas induced by the movement of ions from the vicinity of a high voltage discharge electrode 10.

Basic principles of electrohydrodynamic (EHD) fluid flow are well understood in the art and, in this regard, an article by Jewell-Larsen, N. et al., entitled “Modeling of corona-induced electrohydrodynamic flow with COMSOL multiphysics” (in the Proceedings of the ESA Annual Meeting on Electrostatics 2008) (hereafter, “the Jewell-Larsen Modeling article”), provides a useful summary. Likewise, U.S. Pat. No. 6,504,308, filed Oct. 14, 1999, naming Krichtafovitch et al. and entitled “Electrostatic Fluid Accelerator” describes certain electrode and high voltage power supply configurations useful in some EHD devices. U.S. Pat. No. 6,504,308, together with sections I (Introduction), II (Background), and III (Numerical Modeling) of the Jewell-Larsen Modeling article are hereby incorporated by reference herein for all that they teach.

EHD fluid mover designs described herein can include one or more corona discharge-type emitter electrodes. In general, such corona discharge electrodes include a portion (or portions) that exhibit(s) a small radius of curvature and may take the form of a wire, rod, edge or point(s). Other shapes for the corona discharge electrode are also possible; for example, the corona discharge electrode may take the shape of barbed wire, wide metallic strips, and serrated plates or non-serrated plates having sharp or thin parts that facilitate ion production at the portion of the electrode with the small radius of curvature when high voltage is applied. In general, corona discharge electrodes may be fabricated in a wide range of materials. For example, in some embodiments, compositions such as described in U.S. Pat. No. 7,157,704, filed Dec. 2, 2003, entitled “Corona Discharge Electrode and Method of Operating the Same” and naming Krichtafovitch et al. as inventors may be employed. U.S. Pat. No. 7,157,704 is incorporated herein for the limited purpose of describing materials for some emitter electrodes that may be employed in some corona discharge-type embodiments. In general, a high voltage power supply creates the electric field between corona discharge electrodes and collector electrodes.

EHD fluid mover designs described herein include ion collection surfaces positioned downstream of one or more corona discharge electrodes. Often, ion collection surfaces of an EHD fluid mover portion include leading surfaces of generally planar collector electrodes extending downstream of the corona discharge electrode(s). In some cases, collector electrodes may do double-duty as heat transfer surfaces. In some cases, a fluid permeable ion collection surface may be provided.

In general, collector electrode surfaces may be fabricated of any suitable conductive material, such as aluminum or copper. Alternatively, as disclosed in U.S. Pat. No. 6,919,698 to Krichtafovitch, collector electrodes (referred to therein as “accelerating” electrodes) may be formed of a body of high resistivity material that readily conducts a corona current, but for which a result voltage drop along current paths through the body of high resistivity collector electrode material provides a reduction of surface potential, thereby damping or limiting an incipient sparking event. Examples of such relatively high resistance materials include carbon filled plastic, silicon, gallium arsenide, indium phosphide, boron nitride, silicon carbide, and cadmium selenide. U.S. Pat. No. 6,919,698 is incorporated herein for the limited purpose of describing materials for some collector electrodes that may be employed in some embodiments. Note that in some embodiments described herein, a surface conditioning or coating of high resistivity material (as contrasted with bulk high resistivity) may be employed.

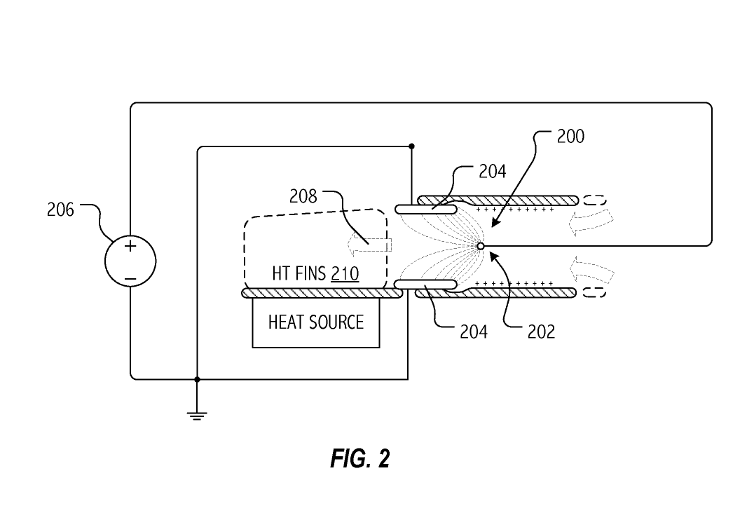

With reference to FIG. 2, an EHD air mover 200 is illustrated in which emitter and collector electrodes 202 and 204 are energized by a high voltage power supply 206 to motivate fluid flow 208 over heat transfer surfaces 210, e.g., heat fins, a heat pipe, or a heat spreader. Typically the motivated fluid is air, although in some embodiments, particular sealed enclosure embodiments, other fluids with constituents not necessarily typical of air, may be used.

In general, a variety of scales, geometries and other design variations are envisioned for electrostatically operative surfaces that functionally constitute a collector electrode, together with a variety of positional interrelationships between such electrostatically operative surfaces and the emitter and/or collector electrodes of a given EHD device. For example, in some implementations, opposing planar collector electrodes are arranged as parallel surfaces proximate to a corona discharge-type emitter wire that is displaced from leading portions of the respective collector electrodes. Nonetheless, other embodiments may employ other electrostatically operative surface configurations or other ion generation techniques and will nonetheless be understood in the descriptive context provided herein.

Typically, when a thermal management system is integrated into an operational environment, heat transfer paths (often implemented as heat pipes or using other technologies) are provided to transfer heat from where it is generated or dissipated to a location(s) within an enclosure where airflow motivated by an EHD device(s) flows over primary heat transfer surfaces. For example, heat generated by various system electronics (e.g., microprocessors, graphics units, etc.) and/or other system components (e.g., light sources, power units, etc.) can be transferred via a heat pipe to radiator fins and then to a cooling fluid and exhausted from the enclosure through a ventilation boundary. Of course, while some implementations may be fully integrated in an operational system such as a laptop or desktop computer, a projector or video display device, printer, photocopier, etc., other implementations may take the form of subassemblies.

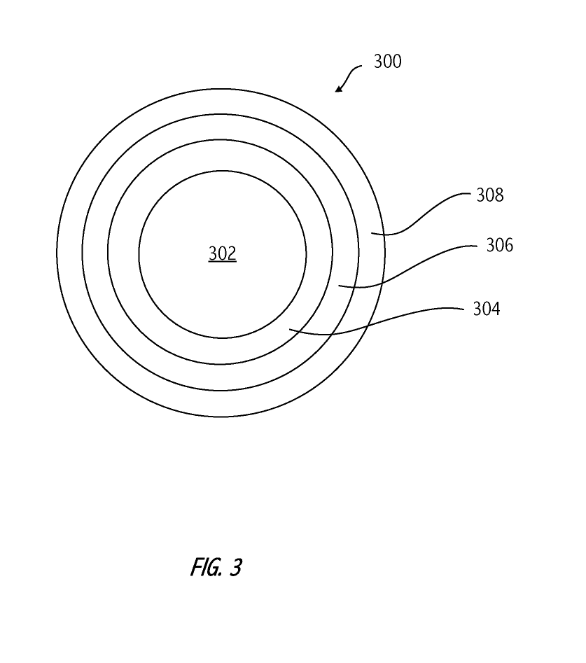

With reference to FIG. 3, an electrode 300 includes an electrode core 302 (e.g., tungsten or titanium) and an intermediate conductive layer 304 (e.g., a Pt group metal) about core 302. A further electrode layer 306 comprises rhodium and presents a hard surface that is resistant to abrasion during frictional cleaning of silica dendrites accumulated on the electrode surface.

In some implementations of electrode 300, intermediate conductive layer 304 is formed via one of electroplating, anodizing, sputter deposition, dip coating and vapor deposited onto electrode core 302. In some instances, the intermediate conductive layer 304 forms a substantially continuous coating over electrode core 302. A further layer 306 is susceptible to compromise from the effects of the corona environment and the intermediate conductive layer 304 protects core 302 following the compromise of further layer 306. Intermediate conductive layer 304 need not be uniform or continuous over the entirety of core 302 nor the rhodium layer over the entirety of the operating surface of electrode 300.

In a particular embodiment, electrode core 302 comprises tungsten and an intermediate conductive layer 304 comprising palladium substantially encapsulates core 302. Further layer 306 comprises rhodium, which presents a hard surface that is robust to mechanical cleaning, but potentially subject to compromise, e.g., micro-cracking, from the corona environment. The underlying palladium intermediate conductive layer 304 serves as a barrier about core 302 to mitigate propagation of micro-cracking or corona erosion of layer 306. A sacrificial layer of conditioning material including silver is periodically deposited over further layer 306 to target ozone or other undesired constituents of an airflow. The sacrificial layer or conditioning material and the further layer 306 of rhodium may be or may become discontinuous due to incomplete coverage, consumption, erosion, micro-cracking and the like. Thus, intermediate conductive layer 304 serves to protect core 302 at locations of compromise of outer layers.

One or more collector electrodes can be positioned in spaced relation to emitter electrode 300 with the electrodes being energizable to motivate fluid flow along a flow path. The multilayered electrode structures described herein can be applied to collector electrodes, accelerator electrodes or any number of other electrodes.

Electrode performance characteristics may also be enhanced or provided by treating the surface of electrode 300 with a conditioning material 308. In some implementations, conditioning material 308 can be applied to the electrode surface and can include an ozone reducing material, e.g., silver or carbon, or other electrode conditioning material. For example, conditioning material 308 can causes electrode 300 to exhibit one or more of ozone reactivity, resistance to oxidation, resistance to corona erosion, low coefficient of friction, and low surface adhesion. In some implementations, the further layer 306 may provide low adhesion or a “non stick” surface, or may exhibit a surface property that repels silica, which is a common material in dendrite formation. As an illustrative example, the electrode conditioning material 308 may include carbon such as graphite, and may have low adhesion to dendrite formation and other detrimental material, and may improve the ease of mechanically removing such detrimental material.

The terms “surface conditioning” and “conditioning materials” may be used to refer to any surface coating, surface deposit, surface alteration or other surface treatment suitable to provide ozone reduction, low surface adhesion, or other surface-specific performance or benefits described herein. For example, in some implementations, ozone reducing materials may be provided on various components in the form of “surface conditioning” on certain surfaces, e.g., on radiator surfaces, collector electrode surfaces, or other component surfaces.

In some implementations, the electrode conditioning material 308 may be selected to have an ozone reduction function, e.g., to catalyze or otherwise reduce ozone generated by the device. As an illustrative example, a material that includes silver (Ag) may be used to reduce ozone in an airflow. Silver may also be used to prevent silica growth. In some embodiments, electrode conditioning material 308 can include at least one of silver (Ag), silver oxide (Ag2O), manganese dioxide (MnO2), oxides of copper (CuO), palladium, cobalt, iron and carbon or other ozone reactive materials. Conditioning material 308 can similarly be selected to target oxides of sulfur or nitrogen or other fluid flow constituents.

As used herein, the terms “ozone reducing material” refers to any material useful to catalyze, bind, sequester or otherwise reduce ozone or other targeted fluid flow constituents. Ozone reducing materials can include ozone catalysts, ozone catalyst binders, ozone reactants or other materials suitable to react with, bind to, or otherwise reduce or sequester ozone. Ozone reducing materials can be selected to also target other undesirable airborne materials and pollutants, for example oxides of nitrogen (NOX).

In some implementations, inductive heating or resistive heating of the electrode for a period can help with ozone reduction (e.g., 1V, 0.05 A, 1 min). In some applications, ozone output levels can be controlled based on:
a. Temperature of catalyst when time EHD is running
b. Temperature of catalyst and time EHD is off
c. EHD off time
d. Number of and Time since last renewal of ozone reducer, e.g., Ag wiping of emitter electrode
e. Power of EHD over time

In some applications, deposition of conditioning material such as Ag is performed with a wiping motion, such as by movement of wearable rods or pads over the emitter wire. The use of rhodium as the further electrode layer has also been shown to aid in ozone reduction. Conditioning materials may be selected to reduce other undesirable constituents of the airflow.

Although in this description and the accompanying drawings the various intermediate layers are described and depicted as being continuous and radially symmetric about the core material, it may be that these layers locally vary in thickness. The local thickness can in some areas diminish to zero so one or more intermediate layers are discontinuous. Examples of local discontinuities include through-thickness cracks and regions where an ozone reducing material is absent through lack of application or consumption.

While electrode 300 is depicted as being substantially circular, any number of profiles may be used in electrode structures. For example, electrode 300 may take the form of a plate, wire, rod, array, needle, cone, or the like and benefit from layered electrode performance characteristics.

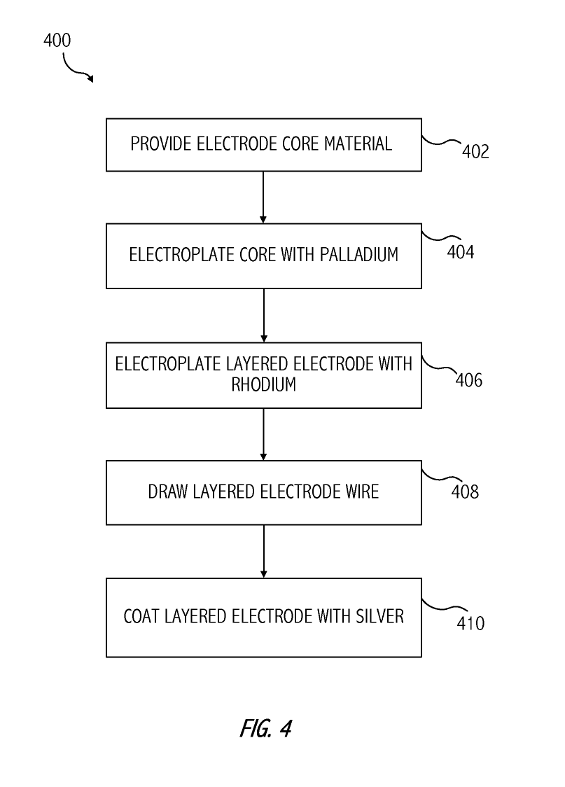

With reference to FIG. 4, a method of making a multi-layered electrode structure is depicted. (400) An electrode core material, e.g., tungsten, is selected to provide tensile strength, conductivity, or other desired performance characteristics. (402) A coating of palladium or other Pt group metal is then deposited, formed or otherwise provided, e.g., via electroplating, as a corona resistant protective barrier around the core. (404) A hard, abrasion resistant layer, e.g., comprising rhodium, is then provided over the Pt group metal layer. (406) The layered electrode structure is further drawn to provide additional wire strength and desired dimensions and surface finish. (408) A surface conditioning material is deposited over the hard abrasion resistant layer to provide desired surface performance characteristics, e.g., ozone reactivity, resistance to oxidation, resistance to corona erosion, low coefficient of friction, and/or low surface adhesion. (410).

In a particular example, a layered electrode wire is prepared beginning with a tungsten wire, which is thinly coated (e.g., electro-plated) with a palladium nickel alloy. The layered electrode is further thinly coated with rhodium, e.g., via electroplating. The layered electrode is then drawn down to increase the strength and surface hardness of the layered electrode. The layered electrode is then provided with an ozone reducing material such as silver.

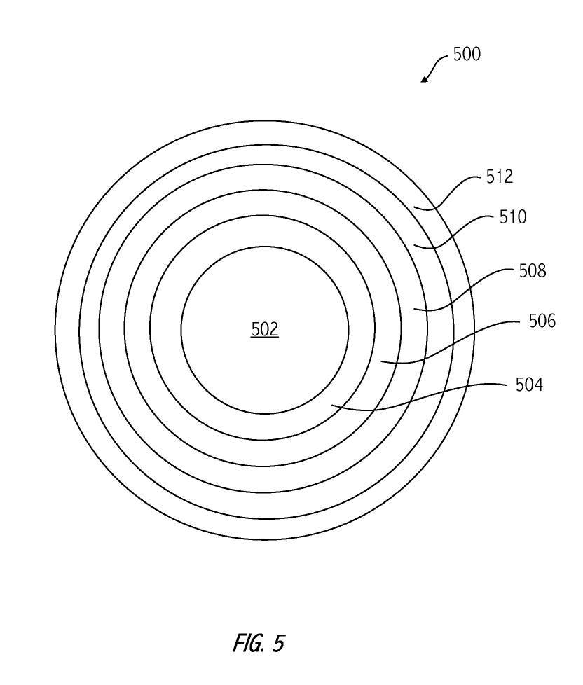

With reference to FIG. 5, a multi-layered electrode structure 500 provides robustness against electrode erosion. An electrode core material 502 is provided with various layers between the core material and an outermost electrode surface 510. Micro-cracking of the electrode surface can accelerate deterioration of the electrode as the micro-cracks expose the underlying conductive layers 504-508 or electrode core material 502. Some electrode core material 502 candidates, e.g., titanium and tungsten, are susceptible to corona plasma induced degradation. A rhodium electrode layer 510 provides an inert, durable electrode surface.

Advantageously, it has been discovered that a layered electrode coating structure can provide a wider range of performance characteristics than a uniform composition electrode structure. For example, a layered structure can mitigate cracking or at least propagation of cracks under corona plasma conditions. One implementation of a multi-layered structure 500 is described, starting from the outermost electrode conditioning material coating 512, e.g., an ozone reducing material, such as silver.

A hard electrode layer 510 comprises rhodium or other material suitably robust in a corona environment and suitably hard to substantially resist abrasion during frictional cleaning of silica dendrites or other debris accumulated thereon. Conductive intermediate Pt group layers 504-508, e.g., Pd, Rh, Ir, Pt, are bonded to electrode core material 502. Adhesion layer materials can be interposed between any number of layers and can include nickel, gold, chromium and titanium. In some implementations, an alloy layer can be formed by providing a solvent metal layer, e.g., Pd, followed by a solute material, e.g., Ni, which is then diffused into the solvent metal to form a solid solution.

In some implementations, the core material is selected for tensile strength and conductivity, e.g., tungsten, steel or a tungsten rhenium alloy. The surface layer of the electrode is preferably selected to resist the abrasive effects of silica dendrite debris that can become embedded in or accumulated on a cleaning device passing over the electrode. Rhodium is desirable as an electrode surface material due to it hardness, resistance to the effects of corona environment, ozone reduction and ease of dendrite removal. In some implementations, 50-100 nanometers of rhodium can be sufficient to provide a hard surface that is robust to abrasion during dendrite removal. Hardness of the electrode surfaces offers greater electrode life and improved reliability by increasing the wear-through time required before the tungsten core or other layers are exposed. Rhodium and other harder materials, however, are more susceptible to formation of microcracks in the corona environment. Accordingly, a palladium-nickel alloy, and optionally multiple different alloy or pure palladium layers, offer increased protection against exposure of the electrode core material following wear through or microcracking of the rhodium layer. For example, a pure palladium layer immediately over the tungsten core can be more resistant to cracking than later palladium-nickel layers and can serve as a final barrier to exposure of the electrode core material to the corona environment.

It will be understood, that a wide range of materials may be used for each of the layers of the layered electrode structure and that additional layers may be added or interposed. Similarly, layers may be combined or omitted depending on the materials selected and desired performance characteristics. Accordingly, a wide range of layered electrode structures are within the scope of the invention.

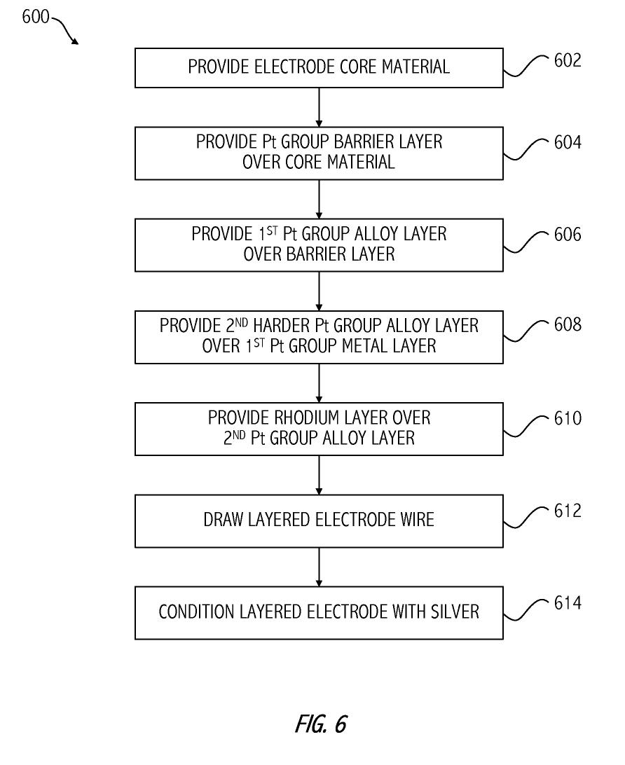

With reference to FIG. 6, a method of making a multi-layered electrode structure is depicted. (600) An electrode core material, e.g., tungsten, is provided and offers tensile strength, conductivity, or other desired electrode performance characteristics. (602) A coating of palladium or other Pt group metal is then deposited, formed or otherwise provided, e.g., via electroplating, as a corona resistant protective barrier around the core. (604) A further coating of an alloy including a Pt group metal, e.g., a palladium nickel alloy of a first composition, is then provided over the protective Pt group barrier layer. (606) It has been experimentally determined that a pure palladium layer is less susceptible to microcracking than a palladium nickel alloy layer and that thinner layers are generally less prone to cracking than thicker layers. A second Pt group alloy layer is then provided over the first Pt group alloy layer, e.g., via electroplating, with the second alloy layer being selected to be harder and more durable than the first alloy layer. (608) A hard, abrasion resistant layer, e.g., comprising rhodium, is then provided over the second Pt group alloy layer. (610) The layered electrode is then drawn to strengthen and harden the electrode layer materials and to attain a desired dimension and surface finish. (612) A surface conditioning material is deposited over the harder electrode layer to provide desired surface performance characteristics, e.g., ozone reactivity, resistance to oxidation, resistance to corona erosion, low coefficient of friction, and/or low surface adhesion. (614).

Deposition or formation of the various electrode layers may be performed via electro-plating, sputter deposition, dip coating, or other suitable processes described herein or practiced in the art. The layers may be of varying thicknesses. The Pt group alloy layers may include different elements, or different ratios of similar elements. For example, a first alloy may be selected for robustness in a corona environment, while another may be selected as a harder abrasion resistant layer.

In a particular implementation, the first Pt group alloy includes palladium and nickel in a ratio of 90/10 and the second Pt group alloy includes palladium and nickel in a ratio of 80/20. The second alloy layer provides a hard layer offering additional electrode life following abrasion of the rhodium layer. Any number of Pt group alloys may be used to form any desired thickness, number or series of electrode layers. For example, harder layers may be formed thinner than softer layers to mitigate microcrack formation. Alternatively, a harder layer may be formed thicker to resist abrasion despite the increased rate of microcrack formation, which can be addressed with a sublayer that serves to mitigate microcrack propagation.

With reference again to FIG. 1, emitter electrode 10 may be energizable to generate ions and may be positioned relative to collector electrode(s) 12 to motivate fluid flow along a fluid flow path. Thus, emitter electrode 10 and collector electrode(s) 12 may at least partially define an EHD fluid accelerator. Any number of additional electrodes may be positioned upstream and downstream of the EHD fluid accelerator along the fluid flow path. For example, in some implementations, a collector electrode can be disposed upstream of the EHD fluid accelerator along the fluid flow path and can operate as an electrostatic precipitator.

In some applications, an EHD product is made by a method that includes positioning a multilayered emitter electrode and at least one other electrode to motivate fluid flow along a flow path when the electrodes are energized. In some applications, the method further includes positioning heat transfer surfaces in the flow path to transfer heat to the fluid flow. The emitter electrode, collector electrode and primary heat transfer surfaces are so positioned and fixed to constitute a thermal management assembly.

In some applications, the method includes introducing the thermal management assembly into an electronic device and thermally coupling a heat generating or dissipating device thereof to the primary heat transfer surfaces. In some cases, the electronic device includes at least one of a computing device, projector, copy machine, fax machine, printer, radio, audio or video recording device, audio or video playback device, communications device, charging device, power inverter, light source, medical device, home appliance, power tool, toy, game console, television, and video display device.

In some implementations, an EHD fluid accelerator includes an emitter electrode and a collector electrode(s) energizable to generate ions and to thereby motivate fluid flow along a flow path. Primary heat transfer surfaces (collectively referred to sometimes as a “radiator”) are positioned downstream of the emitter electrode along the flow path. The radiator is coupled into a heat transfer pathway to dissipate heat from a device into the fluid flow.

In some implementations, the radiator is distinct from the collector electrode, but proximate thereto in the flow path. In some cases, the radiator is positioned immediately downstream of the collector electrode. In some cases, the radiator abuts the collector electrode. In some cases, the radiator is spaced a distance apart from the collector electrode. Still, in some implementations, the downstream radiator and the collector electrode are constituent surfaces of a unitary structure that functions both as the collector electrode and as a radiator. In some cases, the downstream radiator and the collector are separately formed, but joined to form the unitary structure. In some cases, the radiator and collector are integrally formed.

Some implementations of thermal management systems described herein employ EFA or EHD devices to motivate flow of a fluid, typically air, based on acceleration of ions generated as a result of corona discharge. Other implementations may employ other ion generation techniques and will nonetheless be understood in the descriptive context provided herein. Using heat transfer surfaces that may or may not be monolithic or integrated with collector electrodes, heat dissipated by electronics (e.g., microprocessors, graphics units, etc.) and/or other components can be transferred to the fluid flow and exhausted. Typically, when a thermal management system is integrated into an operational environment, heat transfer paths e.g., heat pipes, are provided to transfer heat from where it is dissipated or generated to a location(s) within the enclosure where airflow motivated by an EFA or EHD device(s) flows over heat transfer surfaces.

In general, a variety of scales, geometries, positional interrelationships and other design variations are envisioned for emitter and collector electrodes of a given device. For concreteness of description, certain illustrative implementations, surface profiles and positional interrelationships with other components are described herein. In some implementations, the emitter electrode is an elongated wire and the collector electrode includes two elongated plates substantially parallel to the emitter electrode. Of course, the emitter and collector electrodes may be selected and arranged in any manner suitable to generate ions and thereby motivate fluid flow. For example, planar portions of the collector electrodes may be oriented generally orthogonally to the longitudinal extent of an emitter electrode wire. Any references to leading, trailing, upstream, or downstream are to be understood with directional reference to EHD fluid flow.

In some thermal management system implementations, collector electrodes can provide significant heat transfer to fluid flows motivated therethrough or thereover. In some cases, the collector electrodes can also serve as a primary heat transfer surface. In some thermal management implementations, the primary heat transfer surfaces do not participate substantially in EHD fluid acceleration, i.e., they do not serve as electrodes.

It will be understood that particular EHD design variations are included for purposes of illustration and, persons of ordinary skill in the art will appreciate a broad range of design variations consistent with the description herein. Although implementations of the present invention are not limited thereto, portions of the description herein are consistent with geometries, airflows, and heat transfer paths typical of laptop-type computer electronics and will be understood in view of that descriptive context. Of course, the described implementations are merely illustrative and, notwithstanding the particular context in which any particular implementation is introduced, persons of ordinary skill in the art having benefit of the present description will appreciate a wide range of design variations and exploitations for the developed techniques and configurations. Indeed, EHD device technologies present significant opportunities for adapting structures, geometries, scale, flow paths, controls and placement to meet thermal management challenges in a wide range of applications, systems and devices of various form factors. Moreover, reference to particular materials, dimensions, packaging or form factors, thermal conditions, loads or heat transfer conditions and/or system designs or applications is merely illustrative.

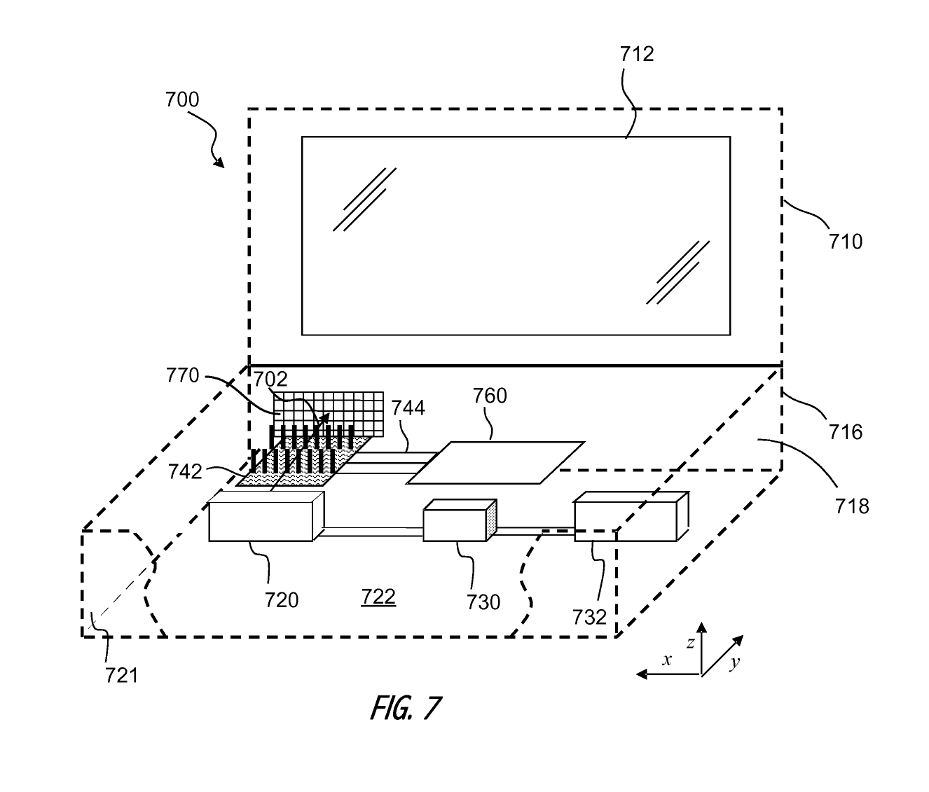

FIG. 7 is a schematic block diagram illustrating one implementation of an environment in which a multilayered electrode may operate. An electronic device 700, such as a computer, includes an EFA or EHD air cooling system 720. Electronic device 700 comprises a housing 716, or case, having a cover 710 that includes a display device 712. A portion of the front surface 721 of housing 716 has been cut away to reveal interior 722. Housing 716 of electronic device 700 may also comprise a top surface (not shown) that supports one or more input devices that may include, for example, a keyboard, touchpad and tracking device. Electronic device 700 further comprises electronic circuit 760 which generates heat in operation. A thermal management solution comprises a heat pipe 744 that draws heat from electronic circuit 760 to heat sink device 742.

Device 720 is powered by high voltage power supply 730 and is positioned proximate to heat sink 742. Electronic device 700 may also comprise many other circuits, depending on its intended use; to simplify illustration of this second implementation. Other components that may occupy interior area 722 of housing 720 have been omitted from FIG. 7.

With continued reference to FIG. 7, in operation, high voltage power supply 730 is operated to create a voltage difference between emitter electrode and collector electrodes disposed in device 720, generating an ion flow or stream that moves ambient air toward the collector electrodes. The moving air leaves device 720 in the direction of arrow 702, traveling through the protrusions of heat sink 742 and through an exhaust grill or opening 770 in the rear surface 718 of housing 716, thereby dissipating heat accumulating in the air above and around heat sink 742. Note that the position of illustrated components, e.g., of power supply 730 relative to device 720 and electronic circuit 760, may vary from that shown in FIG. 7.

Note that electronic device 700 has been greatly simplified for purposes of illustration and the position of illustrated components, e.g., of power supply 730 relative to device 720 and electronic circuit 760, may vary from that shown in FIG. 7. While device 700 is depicted as a laptop computing device, tablet devices, and handheld devices may likewise benefit from EHD cooling and ozone reduction as described.

A controller 732 is connected to device 720 and may use sensor inputs to determine the state of the air cooling system, e.g., to determine a need for cleaning electrodes on a timed or scheduled basis, on a system efficiency measurement basis or by other suitable methods of determining when to clean electrodes. For example, detection of electrode arcing or other electrode performance characteristics may be used to initiate movement of a cleaning device or electrode conditioning device. Electrode performance may be determined, for example, by monitoring voltage levels, current levels, acoustic levels, electrical potentials, determining of the presence of a level of contamination by optical means, detecting an event or performance parameter, or other methods indicating a benefit from mechanically cleaning or conditioning the electrode.

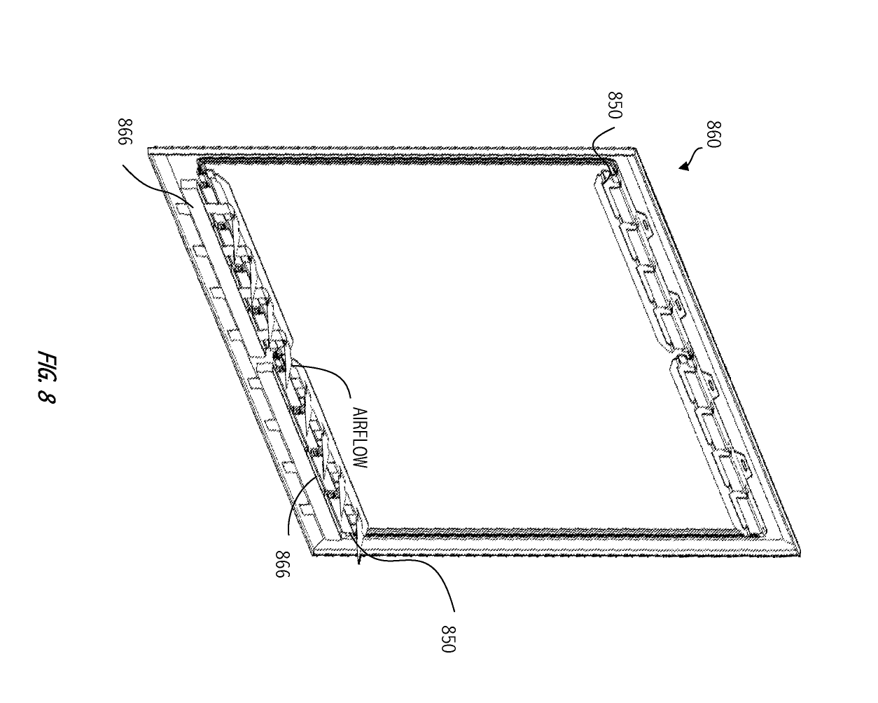

With reference to FIG. 8, in some implementations, one or more EHD air movers 866 including a multilayered electrode may be positioned along an edge of a display device 860, e.g., television or monitor, to provide airflow to dissipate heat generated by a light source 850 of the display device 860. The airflow can travel a flow path extending across a major dimension of the display device or can travel a more localized path. Heat transfer and dissipation can be aided by heat spreaders, heat pipes, or other thermal spreaders/paths. In this example, EHD air movers 866 motivate airflow over a relatively short flow path across heat transfer surfaces associated with light sources 850. The inlets and outlets of the flow path can be defined in any suitable combination of display housing surfaces, e.g., front bezel portions, top or bottom surfaces, lateral surfaces or rearward facing portions of the display device 860.

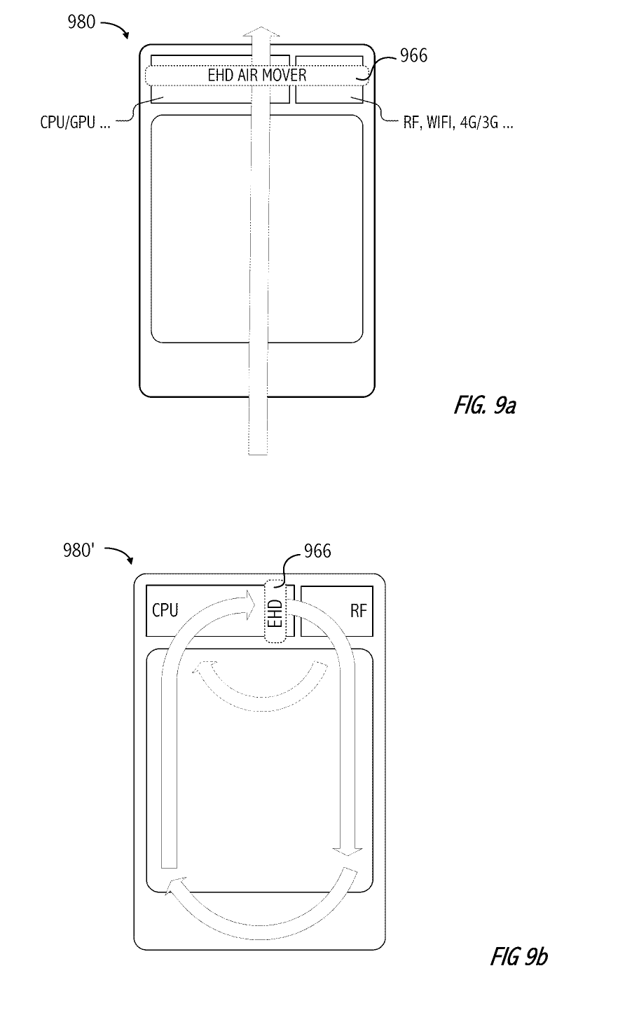

With reference to FIGS. 9a-b, in some implementations, one or more EHD air movers 966 including a multilayered electrode are constructed and arranged to motivate airflow (indicated by broad arrows) through or within a tablet or handheld computing device 980, 980′. For example, airflow may be drawn into and exhausted from device 980 as in FIG. 9a, passing, e.g., over a battery, CPU, display light source, or associated heat transfer surfaces. Alternatively, the airflow may circulate within a substantially sealed portion of an enclosure of device 980′ to better distribute heat for radiative heat transfer from the enclosure to the environment. In some implementations, device 980 has a total thickness of less than about 10 mm and a display surface covers substantially an entire major surface thereof. Any airflow topology and EHD air mover placement may be suitably selected relative to respective electronic assemblies (or circuit boards) for processors (e.g., CPU, GPU, etc.) and/or radio frequency (RF) sections (e.g., WiFi, WiMax, 3G/4G voice/data, GPS, etc.).

In some implementations, an EFA or EHD air cooling system or other similar ion action device employing an electrode cleaning system may be integrated in an operational system such as a laptop or desktop computer, a projector or video display device, etc., while other implementations may take the form of subassemblies. Various features may be used with different devices including EFA or EHD devices such as air movers, film separators, film treatment devices, air particulate cleaners, photocopy machines and cooling systems for electronic devices such as computers, laptops and handheld devices. One or more devices includes one of a computing device, projector, copy machine, fax machine, printer, radio, audio or video recording device, audio or video playback device, communications device, charging device, power inverter, light source, medical device, home appliance, power tool, toy, game console, television, and video display device.

While the foregoing represents a description of various implementations of the invention, it is to be understood that the claims below recite the features of the present invention, and that other implementations, not specifically described hereinabove, fall within the scope of the present invention.

What is claimed is:

1. A multi-layered electrode for use in an electrohydrodynamic device, the electrode comprising:
an elongated electrode core material;
one or more intermediate conductive layers each comprising a platinum group metal disposed about the electrode core material; and
a further electrode layer comprising rhodium over the one or more intermediate conductive layers.

2. The electrode of claim 1, wherein the further layer presents a hard rhodium surface substantially resistant to abrasion during repeated frictional removal of silica dendrites that accumulate thereon during operation of the electrohydrodynamic device.

3. The electrode of claim 1, wherein the one or more intermediate conductive layers includes at least a first intermediate layer comprising substantially pure palladium and a second intermediate layer comprising an alloy of palladium and nickel.

4. The electrode of claim 1, wherein the one or more intermediate conductive layers includes first and second intermediate layers of two different alloys of palladium and nickel, with a harder one of the two alloys positioned over a softer one of the two alloys.

5. The electrode of claim 1, further comprising a sacrificial conditioning material comprising silver deposited over the further electrode layer.

6. The electrode of claim 1, wherein a first of the one or more intermediate conductive layers comprises a substantially pure palladium coating over the electrode core, a second intermediate conductive layer comprises a first palladium nickel alloy coating over the substantially pure palladium coating and a third intermediate conductive layer comprises a second palladium nickel alloy coating over the first palladium alloy coating, wherein the second palladium alloy coating is harder than the first palladium nickel alloy coating.

7. The electrode of claim 6, wherein each successive intermediate conductive layer is increasingly durable to at least partially mitigate exposure of underlying materials to a corona discharge environment following at least one of micro-crack formation, pinhole formation, defect formation, erosion and consumption of a portion of a successive layer.

8. The electrode of claim 6, wherein the second palladium nickel alloy coating is selected to mitigate at least one of abrasion and erosion of a softer first palladium nickel alloy coating in the event of compromise of a portion of the further layer comprising rhodium and of a silver layer over the further layer.

9. A multi-layered electrode for use in an electrohydrodynamic device, the electrode comprising:
an elongated electrode core material;
a first conductive layer comprising a platinum group metal over the electrode core material; and
at least a second conductive layer comprising an alloy of a platinum group metal over the electrode core material, wherein the composition of the second conductive layer differs from the composition of the first conductive layer.

10. The electrode of claim 9, further comprising a further electrode layer comprising rhodium over the second conductive layer.

11. The electrode of claim 9, wherein the first conductive layer comprises substantially pure palladium and the second conductive layer comprises a palladium-nickel alloy.

12. The electrode of claim 9, wherein the electrode core material comprises at least one of tungsten, titanium, steel, tantalum, molybdenum, nickel, and an alloy comprising one of tungsten, titanium, steel, tantalum, molybdenum, and nickel.

13. The electrode of claim 9, wherein the electrode core material comprises tungsten and rhenium.

14. A method of forming an electrode, the method comprising:
providing an electrode core material;
providing a first intermediate conductive layer comprising a platinum group metal over the electrode core material; and
providing a second intermediate electrode layer over the first intermediate conductive layer, the second intermediate electrode layer comprising a different alloy of a platinum group metal than the first intermediate conductive layer.

15. The method of claim 14, wherein the first intermediate conductive layer material comprises at least one of palladium and an alloy of palladium and nickel.

16. The method of claim 14, further comprising providing a further conductive layer comprising rhodium over the second intermediate electrode layer.

17. The method of claim 16, further comprising depositing a conditioning material comprising silver along at least a portion of a length of the electrode.

18. An electrohydrodynamic device (EHD) comprising:
one or more collector electrodes; and
a layered emitter electrode in spaced relation to the one or more collector electrodes; the layered emitter electrode and one or more collector electrodes being energizable to motivate fluid flow along a flow path;
wherein the layered emitter electrode comprises:
an electrode core material;
two or more intermediate conductive layers about the core material, the two or more intermediate conductive layers each comprising a platinum group metal, the first intermediate conductive layer being of a different composition than a second of the intermediate conductive layers; and
a further electrode layer comprising rhodium and presenting a hard surface to resist abrasion during repeated frictional removal of silica dendrite accumulated thereon from operation of the EHD.

19. The device of claim 18, wherein the first intermediate conductive layer comprises palladium and the second intermediate conductive layer comprises a palladium-nickel alloy.

20. The device of claim 18, further comprising a sacrificial silver coating over the further electrode layer.

21. An apparatus comprising:
an enclosure; and
a thermal management assembly for use in convection cooling of one or more devices within the enclosure, the thermal management assembly defining a flow path for conveyance of air between portions of the enclosure over heat transfer surfaces positioned along the flow path to dissipate heat generated by the one or more devices, the thermal management assembly including an electrohydrodynamic (EHD) fluid accelerator comprising:
one or more collector electrodes; and
a layered emitter electrode in spaced relation to the one or more collector electrodes; the layered emitter electrode and one or more collector electrodes being energizable to motivate fluid flow along a flow path;
wherein the layered emitter electrode comprises:
an electrode core material;
one or more intermediate conductive layers about the core material, the one or more intermediate conductive layers each comprising a platinum group metal; and
a further electrode layer comprising a platinum group metal and being of a different composition than the one or more intermediate conductive layers;
wherein the composition of one or more of the intermediate conductive layers is configured to mitigate intralayer propagation of microcracks formed in the further electrode layer.

22. The apparatus of claim 21, wherein the one or more devices includes one of a computing device, laptop computer, tablet computer, smart phone, projector, copy machine, fax machine, printer, radio, audio or video recording device, audio or video playback device, communications device, charging device, power inverter, light source, medical device, home appliance, heater, air cleaner, power tool, toy, game console, set-top console television, and video display device.
